(19) United States
(12) Patent Application Publication
(10) Pub. No.: US 2010/0082854 A1
(43) Pub. Date: Apr. 1, 2010

(54) Real-Time/Batch Interface Arbiter

(76) Inventors: Lars Rossen, Cupertino, CA (US); Peter Michael Bruun, Alleroed (DK)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/239,749

(22) Filed: Sep. 27, 2008

(51) Int. Cl. G06F 9/46

(52) U.S. Cl. 710/39

(57) ABSTRACT

One embodiment of an interface request arbitration system comprises a queue for holding individual processing requests from at least one application process and an interface request arbiter which dynamically chooses to pass a request at the head of the queue to either a real-time interface of an external system that handles the request or a batch interface to the external system.

### TECHNICAL FIELD

The present disclosure is generally related to computer applications and, more particularly, is related to computer application integration.

### BACKGROUND

Service providers often need to integrate a multitude of applications and equipment types, which provide both real-time and batch-oriented interfaces. Bridging between these two interface types is complex, and an industry standard is to use custom-built bridges, which are costly and time-consuming to develop, test, and maintain.

A batch type of interface is often used in cases where, for example, order entry systems are capable of producing a batch input in a suitable format for a service activation process. The real-time type of interface is often used for a point of sale transaction where a prompt response to a request is expected. Functionality, therefore, may be duplicated in two types of workflow, and, the type of the request often inflexibly determines which interface to use.

### SUMMARY

Embodiments of the present disclosure provide an interface request arbitration system comprising a queue for holding individual processing requests from at least one application process and an interface request arbiter which dynamically chooses to pass a request at the head of the queue to either a real-time interface to an external system that handles the request or a batch interface to the external system.

Embodiments of the present disclosure also provide methods for arbitrating interface requests. One embodiment of such a method comprises holding individual processing requests intended for an external system from at least one application process in a queue and dynamically choosing to pass a request at the head of the queue to either a real-time interface to an external system that handles the request or a batch interface to the external system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of a network environment utilizing an interface request arbiter of the present disclosure.

FIG. 2 is a diagram of one embodiment of architecture of an interface request arbiter of FIG. 1.

FIG. 3 is a flow chart diagram representing functionality of one embodiment of the interface request arbiter of FIG. 1.

FIG. 4 is a flow chart diagram representing functionality of one embodiment of the interface request arbiter of FIG. 1.

FIG. 5 is a block diagram of an instruction execution system that can implement the interface request arbiter of FIG. 1.

### DETAILED DESCRIPTION

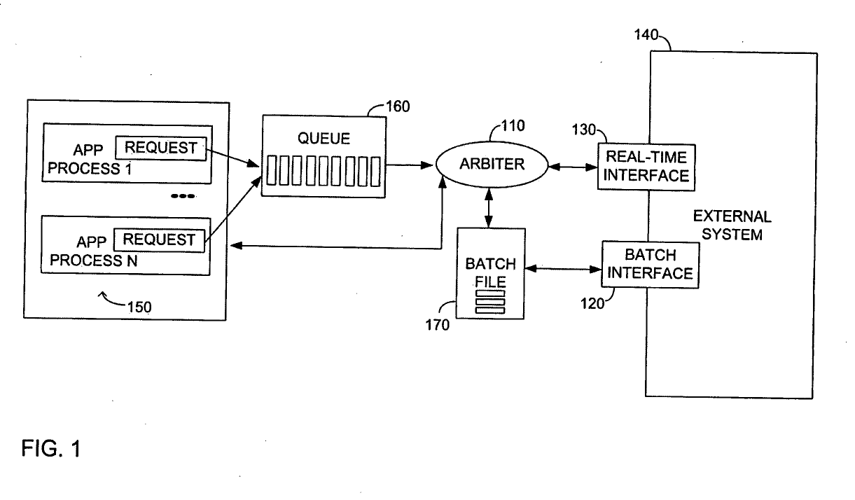

FIG. 1 is a block diagram of one embodiment of a network environment utilizing an interface request arbiter 110 of the present disclosure. In the figure, an interface request arbiter 110 is in front of a batch interface 120 and a real-time interface 130 to an external system 140, in that the interface request arbiter 110 receives individual processing requests from multiple application processes 150 and passes the requests to the external system 140 via the batch interface 120 or the real-time interface 130 to the external system 140. The external system 140 handles the request(s) and prepares response(s) to the request(s). Correspondingly, the interface request arbiter 110 receives the response(s) from the external system 140 and passes the response(s) to the appropriate application process 150.

As explained above, the multiple application processes 150 perform individual processing of requests and then feed their requests to the external system 140 through a queue 160. The interface request arbiter 110 decides when to pass the requests on to the external system 140, and by which interface 120, 130. If the batch interface 120 is selected, the interface request arbiter 110 automatically constructs a batch file 170 to be forwarded to the batch interface 120. The batch response from the external system 140 is received by the interface request arbiter 110 and then automatically dispatched to the respective waiting application processes 150.

As shown by the system of FIG. 1, an application process 150 is isolated from the type of interface 120, 130 it uses on the external system 140. The interface request arbiter 110 is configured to automatically arbitrate on whether to forward a request to either a real-time interface 130 or a batch interface 120.

In one embodiment, the interface request arbiter 110 is configured to decide to forward requests to either the real-time interface 130 or the batch interface 120, based on parameters such as, but not limited to, the size of the queue (N_{q}), the average time to process a real-time request (t_{R}), the average time to process an item in a batch request (t_{B}) and the overhead in producing a batch (t_{BOH}). In one embodiment, the arbiter 110 chooses the interface in order to optimize based on the formula:

min(N_{q}*t_{R}, N_{q}*t_{B}+t_{BOH}).

In one embodiment, the interface request arbiter 110 determines a threshold size of the queue (N_{T}) for which the batch interface 120 should be chosen. Therefore, when the size of the queue is N_{T} or larger (N_{q}≧N_{T}), the batch interface 120 is chosen and a batch file 170 is constructed for each of the current requests in the queue and submitted to the batch interface 120. Otherwise, if the size of the queue is less than N_{T}(N_{q}<N_{T}), the request at the head of the queue 160 is submitted to the real-time interface 130. Therefore, based on latest or outstanding measurements of t_{R}, t_{B}, t_{BOH}, a threshold N_{T} can be determined that is used as a basis for switching from the real-time interface 130 to the batch interface 120. The interface request arbiter 110 may periodically obtain new measurements of performance parameters (e.g., t_{R}, t_{B}, etc.) so that an appropriate threshold size N_{T} can be determined. Further, performance parameters and averages may be computed over a configurable time period.

Accordingly, in some embodiments, the interface request arbiter 110 uses an algorithm for dynamically learning the performance characteristics of the two interfaces 120, 130 and uses this to decide the optimal choice. Whereas in other systems using batch and real-time interfaces 120, 130, an interface is statically selected based on a kind of business process in place (e.g., selection of a real-time interface 130 if the request is from a point of sale terminal or selection of a batch interface 120 if the request is for activation of pre-paid phone cards), the system of FIG. 1 can make a dynamic selection of an interface.

As business environments become more connected, a real-time user interface 130 may not always process a request fast enough in every context. Therefore, use of a real-time interface 130 or a batch interface 120 may be determined independently of what business process is requesting the use.

With the system of FIG. 1, an incoming request is placed in a queue 160, and the arbiter 110 determines whether the request should be passed to the real-time interface 130 or the batch interface 120 (after constructing a batch file 170 with contents of the queue 160) based on real-time performance parameters.

Therefore, using the system of FIG. 1, an interface request arbiter 110 can make the choice of interface dynamically, based on real-time performance parameters while eliminating the complexity of bridging batch and real-time interfaces. The arbiter algorithm can further be enhanced, in some embodiments, to account for a minimum waiting time in the queue 160; to accept an “expedient” flag in request, ensuring the real-time interface 136 is used for these requests; and the self monitoring of actual response times, allowing the arbiter 130 to be self optimizing with respect to interface performance.

Therefore, in addition to or in replacing of parameters such as queue size N_{q}, average process time for a real-time request t_{R}, average time to process a batch request t_{B}, and batch overhead t_{BOH}, additional parameter(s) may be factored into the algorithm that determines which interface to use, such as a minimum waiting time for a request in a queue. Further, an application may designate a request as having a high priority by setting an expedient flag associated with the request. As a result, the request having the expedient flag is moved to the head of the queue 160 so that it receives processing before other requests in the queue 160 and so that the request is passed to the real-time interface 130.

In some embodiments, the overhead in calculating running averages or other parts of an algorithm used to select an interface to be used by the arbiter 110 may also be, but not limited to being, factored or counted in the algorithm that determines which interface to use. Therefore, in some embodiments, the algorithm for determining an interface may be optimized for such effects.

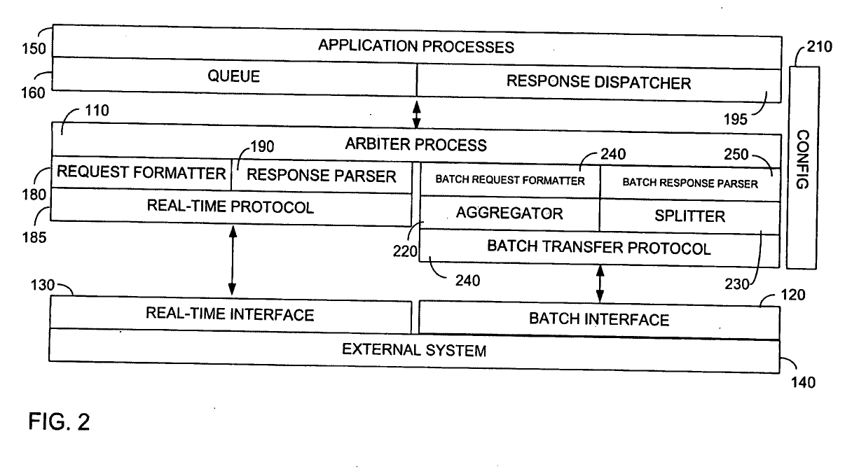

FIG. 2 shows one embodiment of an architecture of the real-time/batch interface request arbiter 110. It is noted that a variety of architectures may be used and the architecture is not limited to that shown in FIG. 2.

In FIG. 2, the arbiter architecture is designed to separate the components of the arbiter 110 from configurable plug-in components 210 that implement the different data formats and protocols used by interfaces on external systems 140.

In the figure, application processes 150 provide a request for the external system 140. The request is placed in a queue 160 and subsequently provided to arbiter process 110 which determines an interface of the external system to use. If the arbiter chooses a real-time interface, the request is formatted for the particular interface type using a request formatter 180. The request is then transmitted to the real-time interface using the appropriate real-time protocol 185.

A response is subsequently received from the real-time interface 130 of the external system 140 using the real-time protocol 185. A response parser 190 analyzes the response and obtains the information to be returned to the application process that originated the request. The arbiter process 110 then uses a response dispatcher 195 to send the response to the appropriate application process 150.

When the request is placed in a queue 160 and subsequently provided to arbiter process 110, the arbiter may choose to use a batch interface. Accordingly, the request is formatted for the particular interface type using a batch request formatter 240. The request is then passed to an aggregator 220 to combine the request with other requests from the queue 160 in a batch file 170. The batch file 170 is then transmitted to the batch interface 120 using the appropriate batch transfer protocol 260.

There may be standard, re-usable implementations of the formatter and transfer components for common formats, such as XML (extensible Markup Language), and for common protocols, such as FTP (File Transfer Protocol) and HTTP/SOAP (HyperText Transfer Protocol/Simple Object Access Protocol). Accordingly, the architecture of FIG. 2 allows re-use of arbiting functionality (110) for a broad range of interfaces by substituting surrounding components (160, 180, 190, 195, 220, 230, 240, 250) with components of other protocol types. For example, in one embodiment, the aggregator/splitter functions (220, 230) can be re-used for all XML based batch-protocols and be substituted with other implementations for other protocol types.

A response is subsequently received from the batch interface 120 of the external system 140 using the batch transfer protocol 240. A splitter 230 separates the individual responses from the batch file received from the external system 140, and a batch response parser 250 analyzes the individual response and obtains the information to be returned to the application process that originated the respective request. The arbiter process 170 then uses a response dispatcher 195 to send the response to the appropriate application process 150.

It is noted that network service providers normally operate their networks from management centers. These centers receive service order requests that are processed through several layers of network management software before ending up as configurations in the network equipment. For example, a service activation solution may receive requests to enable or block new mobile phone numbers. The requests come from different sources, such as order entry or billing systems. Requests involve complex workflow processing before being translated into configuration data for Home Location Registers (HLR) and other equipment.

As previously described, in some network environments, equipment, such as an HLR, may provide two types of interface. One is a real-time request-response oriented interface, where a single mobile number can be enabled, and the result returned. Such interfaces are generally intended for human interaction, and may tend to be slower than automated techniques. In some network service environments, the HLR therefore also supports a batch interface 120, whereby a batch of requests can be supplied, for example by FTP transfer of a batch file 170. The HLR processes these and responds with another batch file containing the results of all the requested operations.

The two types of interface generally often have different capabilities and different performance characteristics. The batch interface 120 may not support all functionality and may impose constraints on which operation types may co-exist in a batch. Furthermore, a mobile service order is likely to involve not only the HLR but also other equipment types to support voice messaging, data services, etc. If these equipment types have batch interfaces, they may impose different limitations, and require different batch file formats and transfer protocols 240.

For comparison purposes, the processing time per request is typically much lower in batch requests, but there is an initial overhead of the batch file compilation and transfer. Since the response must wait for all requests to complete, the delay per operation is significantly larger than with the real-time interface 130. Optimal performance becomes a trade-off between maximal throughput and minimal request delays. Real-time interfaces 130 are optimal in periods with low request rates, while batch interfaces 120 are optimal during high request rate periods. As a result, solutions that employ static and fixed interface configurations may become complex, costly to develop, and maintain.

Therefore, in embodiments of the present disclosure, an interface request arbiter component is configured to consider the tradeoff in performance between the real-time interface 130 and the batch interface 120 and select the interface providing the higher performance. This provides increased efficiency over alternative solutions employing a fixed and static approach. Further, the interface request arbiter component may utilize configurable plug-in components 210 that implement the variety of different data formats and protocols used by interfaces on external systems 140.

Accordingly, embodiments of the interface request arbiter 110 offer unique advantages in terms of dealing with high volume real time requests. Technical benefits include a unique arbitration to optimize system performance using batch and real-time interfaces; a single application interface for batch and real-time interfaces; and a single design that can be implemented in a framework for reuse in many applications, among others. Further, embodiments of the interface request arbiter 110 address a problem of significant stochastic variation in the arrival-rate of requests over time. Since an arrival-rate is not constant, near-constant, or predictable, the interface request arbiter 110 outperforms a system that makes the same interface choice or where the choice to be made is pre-determined.

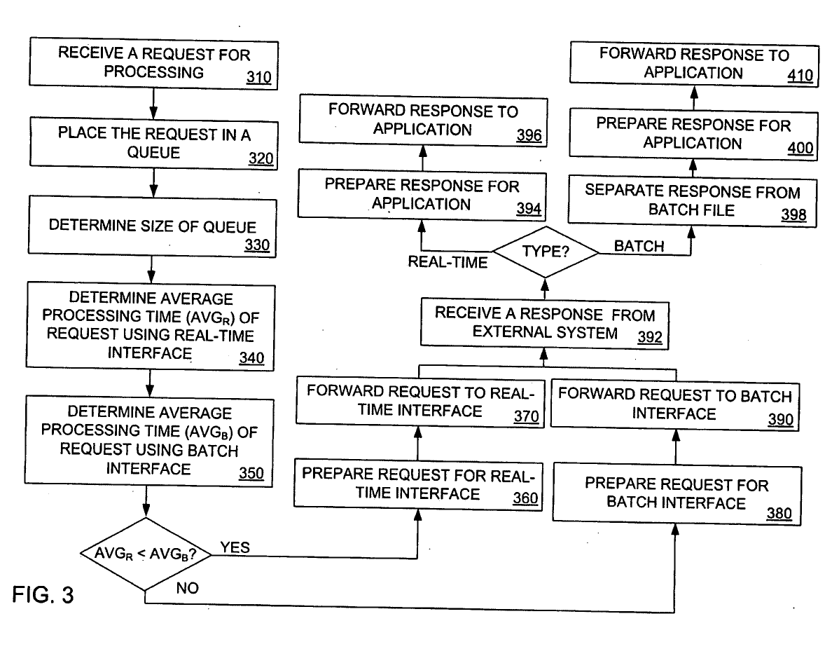

The flow chart of FIG. 3 shows the functionality and operation of an embodiment of the interface request arbiter component. In this regard, each block represents a module, segment, or portion of code, which comprises one or more executable instructions for implementing the specified logical function(s). It should also be noted that in some alternative implementations, the functions noted in the blocks may occur out of the order noted in FIG. 3. For example, two blocks shown in succession in FIG. 3 may in fact be executed substantially concurrently or the blocks may sometimes be executed in the reverse order, depending upon the functionality involved, as will be further clarified hereinbelow.

In FIG. 3, a request is received in block 310. The request is intended for an external system that handles such requests. In block 320, the request is placed in a queue. The size of the queue N_{q} is determined in block 330. Further, an average time value for processing the requests in the queue of size N_{q} using a real-time interface 130 to the external system 140 is determined in block 340. Correspondingly, an average time value for processing the requests in the queue of size N_{q} using a batch interface 120 to the external system 140 is determined in block 350.

In some embodiments, for steps 340 and 350, a running average may be used over a configurable period. Further, averages may persist and be used for faster convergence after a re-start. This may be beneficial where the performance of the different interfaces can fluctuate on a time-scale significantly larger than the maximum duration of burst-rate periods of request arrivals.

Referring back to FIG. 3, if the average time (AVG_{R}) for processing using the real-time interface 130 is equal to or less than the average time (AVG_{B}) for processing using the batch interface 120, the request at the head of the queue 160 is prepared (block 360) for forwarding to the real-time interface 130 to the external system 140, in one embodiment.

For example, the request may be converted into a format compatible for use with the particular real-time interface used by a particular external system. The request is then forwarded (block 370) to the real-time interface 130 of the external system 140.

Otherwise, if the average time (AVG_{B}) for processing using the batch interface 120 is less than the average time (AVG_{R}) for processing using the real-time interface 130, the requests in the queue 160 are aggregated and added to a batch file 170. The batch file 170 is then prepared (block 380) for forwarding to the batch interface 120 of the external system 140. For example, the batch file 170 may be converted into a format compatible for use with the particular batch interface 120 used by a particular external system 140. The batch file is then forwarded (block 390) to the batch interface 120 of the external system 140, in one embodiment.

After processing of a request, a response is received from the external system in block 392. If the response is an individual response from the real-time interface 130, the response is prepared for forwarding (block 394) to the application 150 that is waiting for the response. For example, the response may be converted into a format compatible with the format of the original request that initiated the response. The response is then forwarded (block 396) to the application. If the response is a batch file 170 from the batch interface 130, individual responses are separated from the batch file (block 398) and individual responses are prepared for forwarding (block 400) to the applications 150 that are waiting for the responses. For example, a separated response may be converted into a format compatible with the format of the original request that initiated the response. Each of the responses from the batch file is then forwarded (block 410) to respective application processes 150.

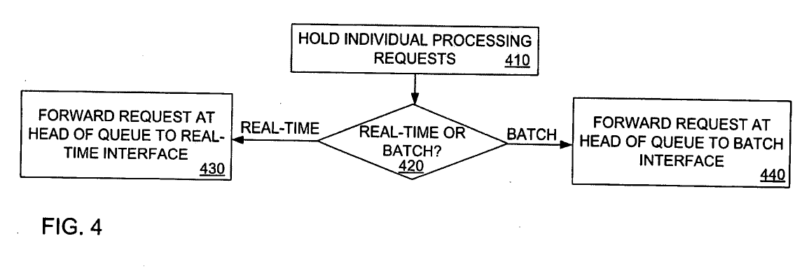

Next, the flow chart of FIG. 4 shows the functionality and operation of an embodiment of the interface request arbiter component. In block 410, individual processing requests intended for an external system from at least one application process are held in a queue. In block 420, a determination is automatically made to forward the request at a head of the queue to either a real-time interface of the external system or to a batch interface to the external system. In some embodiments, the determination may be made based upon a state of the queue and performance parameters reflecting processing efficiency of a request for the different interface types. In block 430, a request at a head of the queue is forwarded to the real-time interface to the external system when selected. In block 440, a request at a head of the queue is forwarded to the batch interface to the external system when selected. As a result, an optimal interface type is chosen based on consideration of current performance parameters.

Certain embodiments of the present disclosure can be implemented in hardware, software, firmware, or a combination thereof. In some embodiment(s), interface request arbiter 110 and other components are implemented in software or firmware that is stored in a memory or other computer readable medium and that is executed by a suitable instruction execution system. If implemented in hardware, as in an alternative embodiment, components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

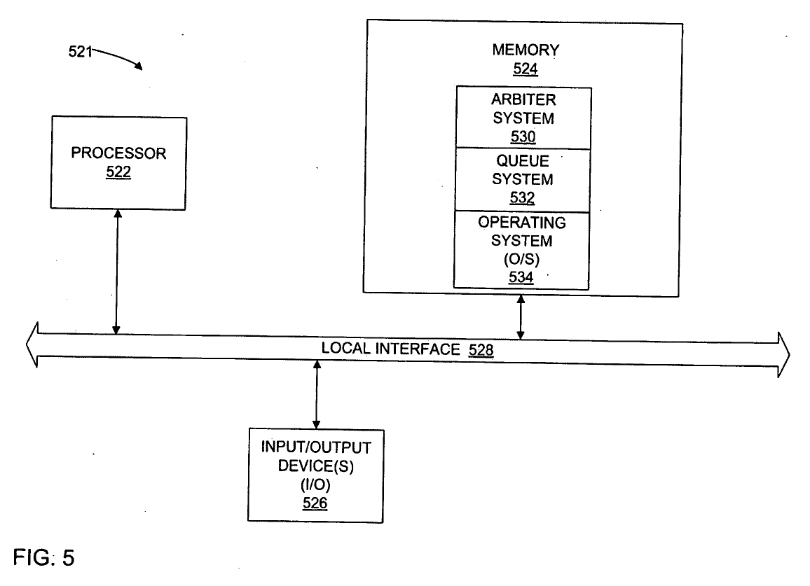

An example of an instruction execution system that can implement the interface request arbiter 110 of the present disclosure is a computer-based device 521 (“computer”) which is shown in FIG. 5. In FIG. 5, the interface request arbiter is denoted by reference numeral 530. Generally, in terms of hardware architecture, as shown in FIG. 5, the computer 521 includes a processor 522, memory 524, and one or more input and/or output (I/O) devices 526 (or peripherals) that are communicatively coupled via a local interface 528. The local interface 528 can be, for example but not limited to, one or more buses or other wired or wireless connections, as is known in the art. The local interface 528 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 522 is a hardware device for executing software, particularly that stored in memory 524. The processor 522 can be any custom made or commercially available processor, a central processing unit (CPU), an auxiliary processor among several processors associated with the computer 521, a semiconductor based microprocessor (in the form of a microchip or chip set), a macroprocessor, or generally any device for executing software instructions.

The memory 524 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 524 may incorporate electronic, magnetic, optical, and/or other types of storage media. Note that the memory 524 can have a distributed architecture, where various components are situated remote from one another, but can be accessed by the processor 522.

The software in memory 524 may include one or more separate programs, each of which comprises an ordered listing of executable instructions for implementing logical functions. In the example of FIG. 5, the software in the memory 524 includes the interface request arbiter 530 and queue 532, in accordance with the present disclosure and a suitable operating system (O/S) 534. The operating system 534 controls the execution of other computer programs and provides scheduling, input-output control, file and data management, memory management, and communication control and related services.

I/O devices 526 may further include devices that communicate both inputs and outputs, for instance but not limited to; a modulator/demodulator (modem; for accessing another device, system, or network), a radio frequency (RF) or other transceiver, a telephonic interface, a bridge, a router, etc.

When the computer 521 is in operation, the processor 522 is configured to execute software stored within the memory 524, to communicate data to and from the memory 524, and to generally control operations of the computer 521 pursuant to the software. The interface request arbiter 530 and the O/S 534, in whole or in part, but typically the latter, are read by the processor 522, perhaps buffered within the processor 522, and then executed.

In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of the present disclosure includes embodying the functionality of the embodiments of the present disclosure in logic embodied in hardware or software-configured mediums.

It should be emphasized that the above-described embodiments are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

Therefore, having just described embodiments of the invention, at least the following is claimed:

1. A system for arbitrating processing requests comprising:
a queue for holding individual processing requests from at least one application process; and
an interface request arbiter configured to dynamically choose to pass a request at the head of the queue to either a real-time interface to an external system that handles the request or a batch interface to the external system.

2. The system of claim 1, wherein the interface request arbiter is configured to automatically construct a batch file to be forwarded to the batch interface containing the request at the head of the queue when the batch interface is chosen.

3. The system of claim 1, wherein the interface request arbiter chooses a batch interface to be used when the average time for processing the requests in the queue, using the real-time interface is greater than the average time for processing the requests in the queue using the batch interface.

4. The system of claim 1, wherein the interface request arbiter chooses a real-time interface to be used when the average time for processing the requests in the queue using the real-time interface is less than the average time for processing the requests in the queue using the batch interface.

5. A method of arbitrating process requests comprising:
holding individual processing requests intended for an external system from at least one application process in a queue; and
dynamically choosing to pass a request at the head of the queue to either a real-time interface to an external system that handles the request or a batch interface to the external system.

6. The method of claim 5, the dynamically choosing action further comprising:
forwarding the request at the head of the queue to the real-time interface to the external system when the average time for processing using the real-time interface is less than the average time for processing using the batch interface; and
forwarding the request at the head of the queue to the batch interface to the external system when the average time for processing using the real-time interface is greater than the average time for processing using the batch interface.

7. The method of claim 5, further comprising:
when the request is chosen to be forwarded to the batch interface, constructing a batch file containing all of the requests in the queue.

8. The method of claim 5, further comprising:
determining a size of the queue N_{q} holding requests intended for processing by the external system;
determining an average time value for processing requests in the queue of size N_{q} using the real-time interface to the external system; and
determining an average time value for processing the requests in the queue of size N_{q} using the batch interface to the external system.

9. The method of claim 8, wherein the determination of the average time value for processing requests using the real-time interface to the external system accounts for a minimum amount of time a request is pending in the queue.

10. The method of claim 8, wherein the determination of the average time value for processing requests using the batch interface to the external system accounts for an average amount of time it takes to construct a batch file.

11. The method of claim 8, further comprising:
periodically determining an average of an amount of time used to process a request using the real-time interface to the external system.

12. The method of claim 8, further comprising:
periodically determining an average of an amount of time used to process a request using the batch interface to the external system.

13. A computer readable medium having instructions executed by a computer system which cause the computer system to:
holding individual processing requests intended for an external system from at least one application process in a queue; and
dynamically choosing to pass a request at the head of the queue to either a real-time interface to an external system that handles the request or a batch interface to the external system.

14. The computer readable medium of claim 13, the dynamically choosing action further comprising:
forwarding the request at the head of the queue to the real-time interface to the external system when the average time for processing using the real-time interface is less than the average time for processing using the batch interface; and
forwarding the request at the head of the queue to the batch interface to the external system when the average time for processing using the real-time interface is greater than the average time for processing using the batch interface.

15. The computer readable medium of claim 13, wherein the executable instructions further comprise:
determining a size of the queue N_{q} holding requests intended for processing by the external system;
determining an average time value for processing requests in the queue of size N_{q} using the real-time interface to the external system; and
determining an average time value for processing the requests in the queue of size N_{q} using the batch interface to the external system.

16. The computer readable medium of claim 15, wherein the determination of the average time value for processing requests using the real-time interface to the external system accounts for a minimum amount of time a request is pending in the queue.

17. The computer readable medium of claim 15, wherein the determination of the average time value for processing requests using the batch interface to the external system accounts for an average amount of time it takes to construct a batch file.

18. The computer readable medium of claim 13, wherein the executable instructions further comprise:
periodically determining an average of an amount of time used to process a request using the real-time interface to the external system.

19. The computer readable medium of claim 13, wherein the executable instructions further comprise:
periodically determining an average of an amount of time used to process a request using the batch interface to the external system.

20. A system for arbitrating processing requests comprising:
means for holding individual processing requests intended for an external system from at least one application process; and
means for dynamically choosing to pass a request at the head of the queue to either a real-time interface to an external system that handles the request or a batch interface to the external system.
